(19) United States
(12) Patent Application Publication
(10) Pub. No.: US 2026/0205772 A1
(43) Pub. Date: Jul. 16, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Lei LIU, Shanghai (CN); Renmao LIU, Shanghai (CN); Fangying XIAO, Shanghai (CN)

(21) Appl. No.: 19/132,473

(22) PCT Filed: Dec. 6, 2023
(86) PCT No.: PCT/CN2023/136728

§ 371 Date: May 23, 2025

(30) Foreign Application Priority Data
Dec. 8, 2022 (CN) 202211575835.0

(51) Int. Cl. H04W 4/029; H04W 76/20; H04W 84/06

(52) U.S. Cl. CPC H04W 4/029; H04W 76/20; H04W 84/06

(57) ABSTRACT

A method performed by a user equipment, including: receiving a flight path configuration sent by a network (step 101); and sending flight path change indication information to the network when a first condition is met (step 103).

### TECHNICAL FIELD

The present invention relates to the technical field of wireless communications. More specifically, the present invention relates to a method for changing and reporting a flight path of an uncrewed aerial vehicle device performed by a user equipment, and a corresponding user equipment.

### BACKGROUND ART

In recent years, various applications of uncrewed aerial vehicles have received increasing attention, such as cooperative operation of multiple uncrewed aerial vehicles, personal entertainment applications, cargo transportation, etc. These applications of uncrewed aerial vehicles may all be implemented or enhanced in service performance on the basis of wireless technology.

LTE Release 15 provides enhancements for uncrewed aerial vehicles to satisfy the requirements of uncrewed aerial vehicles for data transmission, mobility, and other aspects.

At the RAN #94 plenary meeting in December 2021, a work item for NR support of Release 18 for uncrewed aerial vehicle functions was proposed and approved. Reference may be made to Non-Patent Document: RP-213600, New WID on NR support for UAV (Uncrewed Aerial Vehicles). One of the objectives of the work item is to study how an uncrewed aerial vehicle device reports a flight path, so that a network performs control such as mobility management and resource scheduling for the uncrewed aerial vehicle device according to the flight path reported by the uncrewed aerial vehicle device.

The present invention discusses how the uncrewed aerial vehicle device determines a change in the flight path and reports the change in the flight path to the network after the uncrewed aerial vehicle function is supported.

### SUMMARY OF THE INVENTION

To address at least part of the aforementioned problems, the present invention provides a method performed by a user equipment, and a user equipment, which, in one aspect, enables a network to promptly learn a flight path of a UE for purposes such as network planning and UE mobility control and scheduling control, and in another aspect, avoids unnecessary change indication and flight path reporting, thereby reducing waste of radio resources and reducing power consumption.

According to the present invention, provided is a method performed by a user equipment (UE), comprising: receiving a flight path configuration sent by a network; and sending flight path change indication information to the network when a first condition is met.

Preferably, the first condition comprises at least one of the following: the UE being configured to report a flight path change; the UE being configured to report a flight path time information change, and the UE needing to update a flight path due to the flight path change; the UE not being configured to report the flight path time information change, and the UE needing to update the flight path due to a flight path location information change; the UE being configured to report the flight path location information change, and the UE needing to update the flight path due to the flight path change; the UE not being configured to report the flight path location information change, and the UE needing to update the flight path due to the flight path time information change; the UE being configured to report the flight path location information change, and the UE needing to update the flight path due to the flight path location information change; and the UE being configured to report the flight path time information change, and the UE needing to update the flight path due to the flight path time information change.

In addition, according to the present invention, provided is a method performed by a user equipment (UE), comprising: receiving a flight path configuration sent by a network; and sending flight path time change indication information to the network when a first condition is met, and sending flight path location change indication information to the network when a second condition is met.

Preferably, the first condition comprises at least one of the following: the UE being configured to report a flight path change; the UE needing to update a flight path due to a flight path time information change; the UE being configured to report the flight path time information change, and the UE needing to update the flight path due to the flight path change; the UE being configured to report the flight path time information change, and if the UE needs to update the flight path due to the flight path time information change; the UE being configured to report the flight path time information change, and the UE needing to update the flight path because only time information of the flight path has changed but location information of the flight path has not changed; and the UE not being configured to report a flight path location information change, and the UE needing to update the flight path due to the flight path time information change, and the second condition comprises at least one of the following: the UE being configured to report a flight path change; the UE needing to update a flight path due to a flight path location information change; the UE being configured to report the flight path location information change, and the UE needing to update the flight path due to the flight path change; the UE being configured to report the flight path location information change, and the UE needing to update the flight path due to the flight path location information change; the UE being configured to report the flight path location information change, and the UE needing to update the flight path because only location information of the flight path has changed but time information of the flight path has not changed; and the UE not being configured to report a flight path time information change, and the UE needing to update the flight path due to the flight path location information change.

In addition, according to the present invention, provided is a method performed by a user equipment (UE), comprising: receiving a flight path configuration sent by a network; and sending waypoint number change indication information to the network when a first condition is met.

In addition, according to the present invention, provided is a method performed by a user equipment (UE), comprising: receiving a flight path availability configuration sent by a network; and sending flight path availability indication information to the network when a first condition is met.

Preferably, the first condition comprises at least one of the following: the UE being configured to report flight path availability; the UE having an available flight path; after entering an RRC connected state, the UE not having sent a flight path information availability indication to the network; since the UE was configured to report the flight path availability, the UE not having sent a UEAssistanceInformation message with the flight path availability indication information; since the UE entered the RRC connected state, the UE not having sent an RRC message with the flight path availability indication information; the UE being configured to report a flight path location information change, and the UE having available flight path location information; and the UE being configured to report a flight path time information change, and the UE having available flight path time information.

In addition, according to the present invention, provided is a method performed by a user equipment (UE), comprising: receiving a flight path time information availability configuration and/or a flight path location information availability configuration sent by a network; and sending flight path time information availability indication information to the network when a first condition is met, and sending flight path location information availability indication information to the network when a second condition is met.

Preferably, the first condition comprises at least one of the following: after the UE receives an RRCSetup message sent by the network, if the UE has available flight path time information, the UE including the flight path time information availability indication information in an RRCSetupComplete message sent to the network; after the UE receives an RRCReconfiguration message sent by the network, if the UE has the available flight path time information, the UE including the flight path time information availability indication information in an RRCReconfigurationComplete message sent to the network; after the UE receives an RRCResume message sent by the network, if the UE has the available flight path time information, the UE including the flight path time information availability indication information in an RRCResumeComplete message sent to the network; after the UE receives an RRCReestablishment message sent by the network, if the UE has the available flight path time information, the UE including the flight path time information availability indication information in an RRCReestablishmentComplete message sent to the network; since the UE was configured with the flight path time information availability indication information or flight path availability indication information, the UE not having sent a UEAssistanceInformation message with the flight path time information availability indication information, and if the UE has the available flight path time information, the UE including the flight path time information availability indication information in the UEAssistanceInformation message sent to the network; and since the UE entered an RRC connected state, the UE not having sent an RRC message with the flight path time information availability indication information, and if the UE has the available flight path time information, the UE including the flight path time information availability indication information in the UEAssistanceInformation message sent to the network, and the second condition comprises at least one of the following: after the UE receives an RRCSetup message sent by the network, if the UE has available flight path location information, the UE including the flight path location information availability indication information in an RRCSetupComplete message sent to the network; after the UE receives an RRCReconfiguration message sent by the network, if the UE has the available flight path location information, the UE including the flight path location information availability indication information in an RRCReconfigurationComplete message sent to the network; after the UE receives an RRCResume message sent by the network, if the UE has the available flight path location information, the UE including the flight path location information availability indication information in an RRCResumeComplete message sent to the network; after the UE receives an RRCReestablishment message sent by the network, if the UE has the available flight path location information, the UE including the flight path location information availability indication information in an RRCReestablishmentComplete message sent to the network; since the UE was configured with the flight path location information availability indication information or flight path availability indication information, the UE not having sent a UEAssistanceInformation message with the flight path location information availability indication information, and if the UE has the available flight path location information, the UE including the flight path location information availability indication information in the UEAssistanceInformation message sent to the network; and the UE not having sent an RRC message with the flight path location information availability indication information since the UE entered an RRC connected state, and if the UE has the available flight path location information, the UE including the flight path location information availability indication information in the UEAssistanceInformation message sent to the network.

Furthermore, according to the present invention, provided is a user equipment, comprising: a processor; and a memory storing instructions, wherein the instructions, when run by the processor, perform the above method.

According to the present invention, in one aspect, a network is enabled to promptly learn a flight path of a UE for purposes such as network planning and UE mobility control and scheduling control; and in another aspect, unnecessary change indication and flight path reporting is avoided, thereby reducing waste of radio resources and reducing power consumption.

### BRIEF DESCRIPTION OF THE DRAWINGS

FIG. 1 is a flowchart showing a method performed by a user equipment according to Embodiment 1 of the present invention.

FIG. 2 is a flowchart showing a method performed by a user equipment according to Embodiment 2 of the present invention.

FIG. 3 is a flowchart showing a method performed by a user equipment according to Embodiment 4 of the present invention.

FIG. 4 is a flowchart showing a method performed by a user equipment according to Embodiment 5 of the present invention.

FIG. 5 is a flowchart showing a method performed by a user equipment according to Embodiment 6 of the present invention.

FIG. 6 is a simplified structural block diagram of a user equipment (UE) according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For specific meanings of the terms, please see the latest 3GPP standards and specifications.
UE: User Equipment
NR: New Radio
E-UTRA: Evolved Universal Terrestrial Radio Access
LTE: Long Term Evolution
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
AS: Access Stratum
IE: Information Element
CE: Control Element
MIB: Master Information Block
SIB: System Information Block
NG-RAN: NG Radio Access Network
DCI: Downlink Control Information
PHY: physical layer
RB: Radio Bearer
DRB: Data Radio Bearer
SRB: Signalling Radio Bearer
Uu: Air Interface
NAS: Non-Access Stratum
UAV: Uncrewed Aerial Vehicle
TDD: Time Division Duplex
RSRP: Reference Signal Received Power
RSRQ: Reference Signal Received Quality
SS: Synchronization Signal
PBCH: Physical Broadcast Channel
PSSCH: Physical Sidelink Shared Channel
SSB: SS/PBCH block, Synchronization Signal/PBCH block
PCell: Primary Cell
SpCell: Special Cell
UTC: Universal Time Coordinated, also referred to as World Unified Time

In the present invention, a network (or NW), a base station (or gNB or eNB), and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, a user equipment (UE) may refer to a UAV UE, or an NR device (or system) supporting NR UAV functions as described in the background art, or an NR device (or system) supporting broadcasting a UAV identifier, or an NR device (or system) supporting receiving a UAV identifier, or an LTE device (or system) supporting LTE UAV functions, or an LTE device (or system) supporting broadcasting a UAV identifier, or an LTE device (or system) supporting receiving a UAV identifier, or other types of NR devices or LTE devices.

In the present invention, “feedback”, “submit”, “report”, “send”, “transmit” or “transport”, “inform”, “indicate”, and “provide” may be used interchangeably.

In the present invention, “use”, “be available”, “apply”, “implement”, “enable”, “active”, “perform”, and the like may be used interchangeably.

In the present invention, “associate”, “correspond”, and “map” may be used interchangeably.

In the present invention, “UAV”, “UAV UE”, “aerial UE”, “flying UE”, “UAV system” and other names representing devices (or systems) having uncrewed aerial vehicle functions may be used interchangeably.

In the present invention, “configure”, “set”, and “present” may be used interchangeably. In the present invention, “change”, “update”, and “modify” may be used interchangeably. In the present invention, “available”, “accessible”, “obtainable”, “usable”, and “vailable” may be used interchangeably.

In the present invention, “time information” and “time stamp information” may be used interchangeably.

It should be noted that in the present specification, two items that are connected by “and”, “or”, or “and/or” may indicate different expression methods for the same intent in different application scenarios. It is possible that a relationship of including or being included in is present between the two items, but it is not necessary that the two items refer to completely different contents.

Hereinafter, the related art of the present invention is described below.

### Flight Path

An AS layer of a UE may acquire its own flight path via an upper layer (e.g., an application layer). The flight path may include, but is not limited to, a list of waypoints on the path. Information of each waypoint in the list of waypoints may include, but is not limited to: location information of the waypoint, and time information of arrival at the waypoint. The location information of the waypoint may be represented by relevant information of ellipsoidal three-dimensional coordinates. The time information of arrival at the waypoint may be time information at which the UE intends/expects to arrive at the waypoint. The time information may be an absolute time (e.g. UTC time).

### Flight Path Report

In an RRC connection setup procedure, after the UE receives an RRC setup (RRCSetup) message sent by a network, if the UE has an available flight path, the UE includes a flight path information availability indication (flightPathInfoAvailable) in an RRC setup complete (RRCSetupComplete) message sent to the network to indicate that flight path information is available (for example, flightPathInfoAvailable is set to TRUE). Similarly, in an RRC connection reconfiguration procedure, after the UE receives an RRC reconfiguration (RRCReconfiguration) message sent by the network, if the UE has an available flight path, the UE includes the flight path information availability indication (flightPathInfoAvailable) in an RRC reconfiguration complete (RRCReconfigurationComplete) message sent to the network to indicate that the flight path information is available. In an RRC connection resume procedure, after the UE receives an RRC Resume (RRCResume) message sent by the network, if the UE has an available flight path, the UE includes the flight path information availability indication (flightPathInfoAvailable) in an RRC reconfiguration complete (RRCResumeComplete) message sent to the network to indicate that the flight path information is available. In an RRC connection reestablishment procedure, after the UE receives an RRC reestablishment (RRCReestablishment) message sent by the network, if the UE has an available flight path, the UE includes the flight path information availability indication (flightPathInfoAvailable) in an RRC reconfiguration complete (RRCReestablishmentComplete) message sent to the network to indicate that the flight path information is available.

The network side may determine, according to the flight path information availability indication (flightPathInfoAvailable) reported by the UE in the above procedures, whether to request the UE to report the flight path. The UE receives a UE information request (UEInformationRequest) message sent by the network. If the UEInformationRequest message includes a flight path information request (flightPathInfoReq) configuration, and if the UE has the available flight path information, the UE includes a flight path information report (flightPathInfoReport) in a UE information response (UEInformationResponse) message, and configures the flight path information report to include a list of waypoints along the flight path. Further, the flightPathInfoReq configuration may include, but is not limited to, the following configurations: the maximum number of waypoints, and a time stamp inclusion indication (includeTimeStamp). The number of waypoints in the list of waypoints in flightPathInfoReport does not exceed the maximum number of waypoints. If includeTimeStamp is included in flightPathInfoReq (and includeTimeStamp is set to TRUE), and if time stamp information is available at the UE side, then the UE sets a time stamp (timeStamp) field in flightPathInfoReport to the time when the UE intends/expects to arrive at each waypoint. The UE submits a UEInformationResponse message to a lower layer for transmission.

The time stamp information is included in the flight path information report reported by the UE only when it is configured at the network side to be required to be included, otherwise the time stamp information is not included in the flight path information report. This is determined by the purpose for which the network needs the UE to report the flight path. For example, when the network only uses the flight path report of the UE to determine how a cell range is divided, etc., the network may not need the time stamp information of the waypoints in the flight path but only needs the location information of the waypoints in the flight path.

Flight path change For an NR UAV, if the flight path has changed, the UE may send change indication information to the network. After receiving the change indication information sent by the UE, the network may request, by sending the UEInformationRequest message to the UE, the UE to report the flight path report. Since the information of a waypoint in the flight path may include location information of the waypoint and time information of arrival at the waypoint, there are various possibilities for the flight path change: the location information of the flight path has not changed, but the time information has changed; the location information of the flight path has changed, but the time information has not changed; both the location information and the time information of the flight path have changed.

For various situations of flight path changes, the present invention discusses how the UE determines that the flight path has changed and how the UE indicates to the network after the flight path has changed, which, in one aspect, enables the network to promptly learn the flight path of the UE for purposes such as network planning and UE mobility control and scheduling control, and in another aspect, avoids unnecessary change indication and flight path reporting, thereby reducing waste of radio resources and reducing power consumption.

Hereinafter, several embodiments of the present invention for addressing the above problems are described in detail.

### Embodiment 1

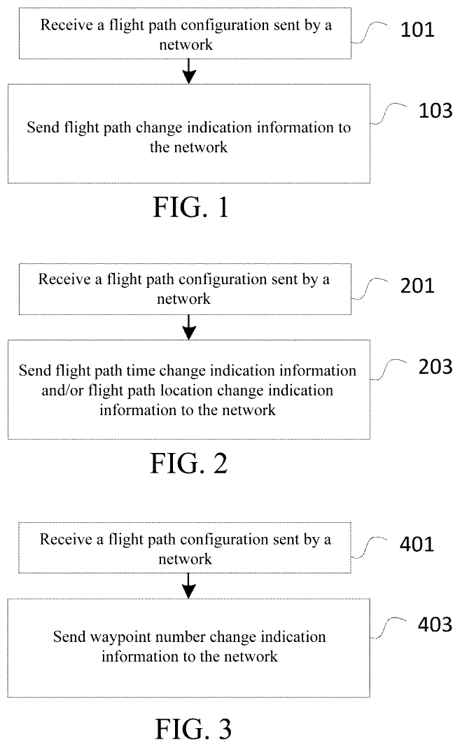

FIG. 1 is a flowchart showing a method performed by a user equipment according to Embodiment 1 of the present invention.

As shown in FIG. 1, steps 101 and 103 are optionally included in the present embodiment.

Optionally, in step 101, the UE receives a flight path configuration sent by a network.

The flight path configuration may be included in a system message, or an RRC dedicated message (e.g., an RRC reconfiguration (RRCReconfiguration) message), or a MAC CE.

Optionally, the flight path configuration may include at least one of the following instances of information: a flight path change configuration, a flight path time change configuration, and a flight path location change configuration. The flight path change configuration is used to configure the UE to report a change in a flight path, the flight path time change configuration is used to configure the UE to report a flight path time information change, and the flight path location change configuration is used to configure the UE to report a flight path location information change.

Optionally, the flight path configuration may be included in an other configuration (otherConfig) information element in the RRCReconfiguration message.

The “change in the flight path” may refer to at least one of the following meanings:
a flight path time information change, and/or a flight path location information change;
time information of a waypoint of the flight path has changed and/or location information of a waypoint in the flight path has changed.

The “flight path time information change” may refer to at least one of the following meanings:
the time information of the flight path has changed;
only the time information of the flight path has changed (that is, the location information has not changed);
the time information of a waypoint in the flight path has changed;
only the time information of a waypoint in the flight path has changed (that is, the location information has not changed).

The “flight path location information change” may refer to at least one of the following meanings:
the location information of the flight path has changed;
only the location information of the flight path has changed (that is, the time information has not changed);
the location information of a waypoint in the flight path has changed;
only the location information of a waypoint in the flight path has changed (that is, the time information has not changed).

The “waypoint” may refer to any waypoint, may refer to all waypoints, or may also refer to some waypoints (the number of the waypoints exceeds a certain threshold, and optionally, the threshold may be configured by the network via a system message or an RRC dedicated message).

The “flight path time information change” may also be expressed as “a flight path change due to a change in time information”. The “flight path location information change” may also be expressed as “a flight path change due to a change in location information”. “Only the time information has changed” may also be expressed as “a change only due to a change in time information”. “Only the location information has changed” may also be expressed as “a change only due to a change in location information”.

Optionally, the UE considers itself to be configured to report a flight path time information change in one of the following cases:
if the UE receives a flight path time change configuration sent by the network;
if the UE receives a flight path change configuration sent by the network, and if the UE receives a flight path time change configuration sent by the network.

Optionally, the UE considers itself to be configured to report a flight path location information change in one of the following cases:
if the UE receives a flight path location change configuration sent by the network;
if the UE receives a flight path change configuration sent by the network, and if the UE receives a flight path location change configuration sent by the network.

Optionally, if the UE receives the flight path change configuration sent by the network, the UE considers itself to be configured to report a flight path change.

“If the UE receives a flight path time change configuration sent by the network” may also be expressed as “if the flight path time change configuration is set to setup”, or as “if the flight path time change configuration is included in the otherConfig information element”, or as “if the flight path time change configuration is included in the RRCReconfiguration message”.

“If the UE receives a flight path change configuration sent by the network” may also be expressed as “if the flight path change configuration is set to setup”, or as “if the flight path change configuration is included in the otherConfig information element”, or as “if the flight path change configuration is included in the RRCReconfiguration message”. “If the UE receives a flight path location change configuration sent by the network” may also be expressed as “if the flight path location change configuration is set to setup”, or as “if the flight path location change configuration is included in the otherConfig information element”, or as “if the flight path location change configuration is included in the RRCReconfiguration message”.

Optionally, in step 103, the UE sends flight path change indication information to the network when at least one of the following conditions is met, wherein the flight path change indication information is used to indicate a flight path change:
the UE being configured to report a flight path change;
the UE being configured to report a flight path time information change, and the UE needing to update a flight path due to the flight path change;
the UE not being configured to report the flight path time information change, and the UE needing to update the flight path due to a flight path location information change;
the UE being configured to report the flight path location information change, and the UE needing to update the flight path due to the flight path change;
the UE not being configured to report the flight path location information change, and the UE needing to update the flight path due to the flight path time information change;
the UE being configured to report the flight path location information change, and the UE needing to update the flight path due to the flight path location information change; and
the UE being configured to report the flight path time information change, and the UE needing to update the flight path due to the flight path time information change.

The order in which the above conditions are arranged is irrelevant to the conditions, that is, the order of the above conditions may be changed.

The flight path change indication information may be included in an RRC dedicated message (e.g., a UE assistance information (UEAssistanceInformation) message) or a MAC CE.

Optionally, the UE initiates the transmission of the RRC dedicated message (e.g., the UEAssistanceInformation message) or the MAC CE to send the flight path change indication information.

Optionally, if the transmission of the RRC dedicated message or the MAC CE is initiated to send the flight path change indication information, the UE sets a flight path change indication to TRUE, and submits the RRC dedicated signaling (e.g., the UEAssistanceInformation message) or the MAC CE to a lower layer for transmission.

### Embodiment 2

FIG. 2 is a flowchart showing a method performed by a user equipment according to Embodiment 2 of the present invention.

As shown in FIG. 2, steps 201 and 203 are optionally included in the present embodiment.

Optionally, step 201 is the same as step 101.

Optionally, in step 203, the UE sends flight path time change indication information to the network when at least one of the following conditions is met:
the UE being configured to report a flight path change;
the UE needing to update a flight path due to a flight path time information change;
the UE being configured to report the flight path time information change, and the UE needing to update the flight path due to the flight path change;
the UE being configured to report the flight path time information change, and if the UE needs to update the flight path due to the flight path time information change;
the UE being configured to report the flight path time information change, and the UE needing to update the flight path because only time information of the flight path has changed (that is, location information of the flight path has not changed); and
the UE not being configured to report a flight path location information change, and the UE needing to update the flight path due to the flight path time information change.

The order in which the above conditions are arranged is irrelevant to the conditions, that is, the order of the above conditions may be changed.

The flight path time change indication information is used to indicate the flight path time information change, and/or indicate that only the time information of the flight path has changed.

Optionally, step 203 may further include: the UE sending flight path location change indication information to the network when at least one of the following conditions is met:
the UE being configured to report a flight path change;
the UE needing to update a flight path due to a flight path location information change;
the UE being configured to report the flight path location information change, and the UE needing to update the flight path due to the flight path change;
the UE being configured to report the flight path location information change, and the UE needing to update the flight path due to the flight path location information change;
the UE being configured to report the flight path location information change, and the UE needing to update the flight path because only location information of the flight path has changed (that is, time information of the flight path has not changed); and
the UE not being configured to report a flight path time information change, and the UE needing to update the flight path due to the flight path location information change.

The order in which the above conditions are arranged is irrelevant to the conditions, that is, the order of the above conditions may be changed.

The flight path location change indication information is used to indicate the flight path location information change, and/or indicate that only the location information of the flight path has changed.

Optionally, the flight path time change indication information and/or the flight path location change indication information may be included in an RRC dedicated message (e.g., a UEAssistanceInformation message) or a MAC CE.

Optionally, the UE initiates the transmission of the RRC dedicated message (e.g., the UEAssistanceInformation message) or the MAC CE to send the flight path time change indication information and/or the flight path location change indication information to the network.

Optionally, if the transmission of the RRC dedicated message or the MAC CE is initiated to send the flight path time change indication information to the network, and if the time information of the flight path has changed or if only the time information of the flight path has changed, the UE sets a flight path time change indication to TRUE, otherwise the UE sets the flight path time change indication to FALSE. The RRC dedicated message (e.g., the UEAssistanceInformation message) or the MAC CE is submitted to a lower layer for transmission.

Optionally, if the transmission of the RRC dedicated message or the MAC CE is initiated to send the flight path location change indication information to the network, and if the location information of the flight path has changed or if only the location information of the flight path has changed, the UE sets a flight path location change indication to TRUE, otherwise the UE sets the flight path location change indication to FALSE. The RRC dedicated signaling (e.g., the UEAssistanceInformation message) or the MAC CE is submitted to a lower layer for transmission.

### Embodiment 3

According to Embodiment 1, optionally, the UE may consider (or determine) that the location information of the flight path has changed if at least one of the following conditions is met:
the flight path is available and/or if the location information of the flight path is available;
location information of a waypoint in a flight path reported previously is not included in the current flight path;
the arrangement order of waypoints in the current flight path has changed compared with waypoints in the flight path reported previously (that is, the location information arrangement order of the waypoints is different); and
the number of waypoints in the current flight path has increased or decreased compared with the number of waypoints in the flight path reported previously (that is, the number of waypoints is different).

The order in which the above conditions are arranged is irrelevant to the conditions, that is, the order of the above conditions may be changed.

Optionally, the UE may consider (or determine) that the time information of the flight path has changed if at least one of the following conditions is met:
the flight path is available and/or if the time information of the flight path is available;
time information of non-expired waypoints in the flight path reported previously has changed; and
the time information arrangement order of the waypoints in the current flight path has changed as compared with waypoints in the flight path reported previously (that is, the time information arrangement order of the waypoints is different).

The order in which the above conditions are arranged is irrelevant to the conditions, that is, the order of the above conditions may be changed.

Optionally, the UE may consider (or determine) that flight path information has changed if at least one of the following conditions is met:
the flight path is available, and/or the location information of the flight path is available, and/or the time information of the flight path is available;
the location information of a waypoint in the flight path reported previously is not included in the current flight path;
the arrangement order of waypoints in the current flight path has changed compared with waypoints in the flight path reported previously (that is, the arrangement order of the waypoints is different);
the number of waypoints in the current flight path has increased or decreased compared with the number of waypoints in the flight path reported previously (that is, the number of waypoints is different);
the time information of non-expired waypoints in the flight path reported previously has changed; and
the time information arrangement order of waypoints in the current flight path has changed compared with the waypoints in the flight path reported previously.

The order in which the above conditions are arranged is irrelevant to the conditions, that is, the order of the above conditions may be changed.

The “waypoint” may refer to any waypoint, may refer to all waypoints, or may also refer to some waypoints (the number of the waypoints exceeds a certain threshold, and optionally, the threshold may be configured by the network via a system message or an RRC dedicated message).

### Embodiment 4

FIG. 3 is a flowchart showing a method performed by a user equipment according to Embodiment 4 of the present invention.

As shown in FIG. 3, steps 401 and 403 are optionally included in the present embodiment.

Optionally, step 401 is the same as step 101.

Optionally, according to Embodiment 3, if the UE considers that a flight path information change or a flight path location information change is due to a change (increase or decrease) in the number of waypoints in the current flight path compared with the number of waypoints in the flight path reported previously, then in step 403, the UE sends waypoint number change indication information to the network, wherein the waypoint number change indication information is used to indicate whether the number of waypoints has changed. Optionally, the waypoint number change indication information may indicate whether the number of waypoints has increased or decreased.

Optionally, the UE initiates transmission of an RRC dedicated message (e.g., a UEAssistanceInformation message) or a MAC CE to send the waypoint number change indication information.

Optionally, if the number of waypoints of the flight path has changed, the UE sets a waypoint number change indication to TRUE. The RRC dedicated signaling (e.g., the UEAssistanceInformation message) or the MAC CE is submitted to a lower layer for transmission.

Or, optionally, if the number of waypoints of the flight path has increased compared with the flight path reported previously, the UE sets the waypoint number change indication information to TRUE, and if the number of waypoints of the flight path has decreased compared with the flight path reported previously, the UE sets the waypoint number change indication information to FALSE. The RRC dedicated signaling (e.g., the UEAssistanceInformation message) or the MAC CE is submitted to a lower layer for transmission.

### Embodiment 5

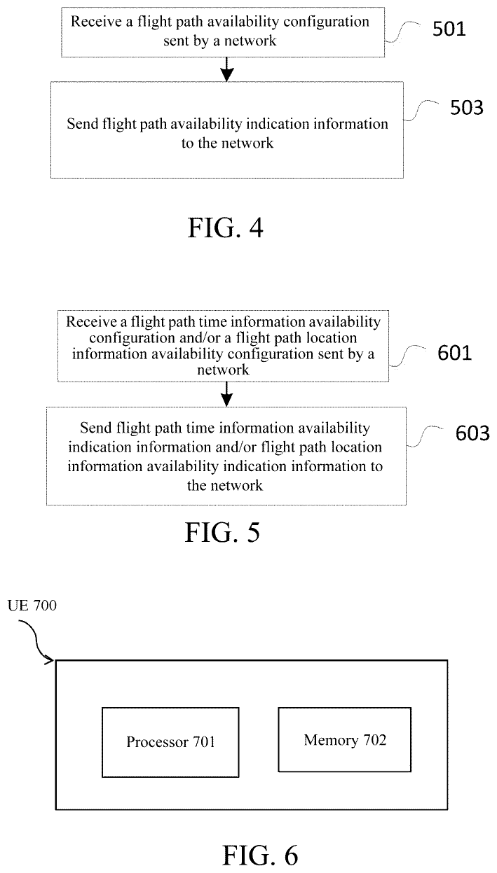

FIG. 4 is a flowchart showing a method performed by a user equipment according to Embodiment 5 of the present invention.

As shown in FIG. 4, steps 501 and 503 are optionally included in the present embodiment.

Optionally, in step 501, the UE receives a flight path availability configuration sent by a network. The flight path availability configuration may be included in a system message, or an RRC dedicated message (e.g., an RRC reconfiguration (RRCReconfiguration) message), or a MAC CE. The flight path availability configuration is used to configure the UE to report flight path availability indication information. Optionally, the flight path availability configuration may be included in an other configuration (otherConfig) information element in the RRCReconfiguration message.

Optionally, in step 503, the UE sends the flight path availability indication information to the network when at least one of the following conditions is met:
the UE being configured to report flight path availability;
the UE having an available flight path;
the UE (after entering an RRC connected state) not having sent a flight path information availability indication to the network;
since the UE was configured to report the flight path availability, the UE not having sent a UEAssistanceInformation message with the flight path availability indication information;
(since the UE entered the RRC connected state), the UE not having sent an RRC message with the flight path availability indication information;
the UE being configured to report a flight path location information change, and the UE having available flight path location information; and
the UE being configured to report a flight path time information change, and the UE having available flight path time information.

The order in which the above conditions are arranged is irrelevant to the conditions, that is, the order of the above conditions may be changed.

Optionally, “availability” may also mean changing from unavailability to availability.

Optionally, the flight path availability may include, but is not limited to, time information availability and location information availability.

Optionally, the flight path availability indication information may be included in an RRC dedicated message (e.g., a UEAssistanceInformation message) or a MAC CE.

Optionally, if the transmission of the RRC dedicated message or the MAC CE is initiated to send the flight path availability indication information, and if the flight path is available, then the UE sets the flight path availability indication information to TRUE. Optionally, if the transmission of the RRC dedicated message or the MAC CE is initiated to send the flight path availability indication information, and if the flight path is invalid, then the UE sets a flight path availability indication to FALSE, and submits the RRC dedicated signaling (e.g., the UEAssistanceInformation message) or the MAC CE to a lower layer for transmission. The flight path being invalid may mean that the UE cannot acquire the flight path, or that a flight path reported previously is already invalid, or that a waypoint of the flight path reported previously is already invalid, or that the time information of the flight path reported previously is invalid (for example, the time information of all waypoints is invalid), or that the location information of the flight path reported previously is invalid. The flight path being invalid may be due to reasons such as outdated time information of the waypoints or the waypoints having already been passed.

Optionally, the “flight path availability configuration” and the “flight path configuration” may be represented by the same information element, or the “flight path configuration” may also be used to configure the UE to report the flight path availability indication information. In this case, the behavior of the UE can be obtained by replacing the “flight path availability configuration” in each step in the present embodiment with the “flight path configuration”.

Optionally, “flight path change indication information” may also be used to indicate the availability of a flight path. In this case, the behavior of the UE can be obtained by replacing the “flight path availability indication information” in each step in the present embodiment with the “flight path change indication information”.

Optionally, “flight path location change indication information” may also be used to indicate the availability of a flight path. In this case, the behavior of the UE can be obtained by replacing the “flight path availability indication information” in each step in the present embodiment with the “flight path location change indication information”.

Optionally, “flight path time change indication information” may also be used to indicate the availability of a flight path. In this case, the behavior of the UE can be obtained by replacing the “flight path availability indication information” in each step in the present embodiment with the “flight path time change indication information”.

### Embodiment 6

FIG. 5 is a flowchart showing a method performed by a user equipment according to Embodiment 6 of the present invention.

As shown in FIG. 5, according to Embodiment 5, steps 601 and 603 are optionally included in the present embodiment.

Optionally, in step 601, the UE receives a flight path time information availability configuration and/or a flight path location information availability configuration and/or a flight path availability configuration sent by a network. The flight path time information availability configuration and/or the flight path location information availability configuration may be included in a system message, or an RRC dedicated message (e.g., an RRC reconfiguration (RRCReconfiguration) message), or a MAC CE. The flight path time information availability configuration may be used to configure the UE to report flight path time information availability indication information. The flight path location information availability configuration may be used to configure the UE to report flight path location information availability indication information. Optionally, the flight path time information availability configuration and/or the flight path location information availability configuration may be included in an other configuration (otherConfig) information element in the RRCReconfiguration message.

Optionally, in step 603, the UE sends the flight path time information availability indication information to the network when at least one of the following conditions is met:
after the UE receives an RRCSetup message sent by the network, if the UE has available flight path time information, the UE including the flight path time information availability indication information in an RRCSetupComplete message sent to the network;
after the UE receives an RRCReconfiguration message sent by the network, if the UE has the available flight path time information, the UE including the flight path time information availability indication information in an RRCReconfigurationComplete message sent to the network;
after the UE receives an RRCResume message sent by the network, if the UE has the available flight path time information, the UE including the flight path time information availability indication information in an RRCResumeComplete message sent to the network;
after the UE receives an RRCReestablishment message sent by the network, if the UE has the available flight path time information, the UE including the flight path time information availability indication information in an RRCReestablishmentComplete message sent to the network;
since the UE was configured with the flight path time information availability indication information (or flight path availability indication information), the UE not having sent a UEAssistanceInformation message with the flight path time information availability indication information, and if the UE has the available flight path time information, the UE including the flight path time information availability indication information in the UEAssistanceInformation message sent to the network; and
(since the UE entered an RRC connected state), the UE not having sent an RRC message with the flight path time information availability indication information, and if the UE has the available flight path time information, the UE including the flight path time information availability indication information in the UEAssistanceInformation message sent to the network.

The order in which the above conditions are arranged is irrelevant to the conditions, that is, the order of the above conditions may be changed.

Optionally, step 603 may further include the UE sending the flight path location information availability indication information to the network when at least one of the following conditions is met:
after the UE receives an RRCSetup message sent by the network, if the UE has available flight path location information, the UE including the flight path location information availability indication information in an RRCSetupComplete message sent to the network;
after the UE receives an RRCReconfiguration message sent by the network, if the UE has the available flight path location information, the UE including the flight path location information availability indication information in an RRCReconfigurationComplete message sent to the network;
after the UE receives an RRCResume message sent by the network, if the UE has the available flight path location information, the UE including the flight path location information availability indication information in an RRCResumeComplete message sent to the network;
after the UE receives an RRCReestablishment message sent by the network, if the UE has the available flight path location information, the UE including the flight path location information availability indication information in an RRCReestablishmentComplete message sent to the network;
since the UE was configured with the flight path location information availability indication information (or flight path availability indication information), the UE not having sent a UEAssistanceInformation message with the flight path location information availability indication information, and if the UE has the available flight path location information, the UE including the flight path location information availability indication information in the UEAssistanceInformation message sent to the network; and
(since the UE entered an RRC connected state), the UE not having sent an RRC message with the flight path location information availability indication information, and if the UE has the available flight path location information, the UE including the flight path location information availability indication information in the UEAssistanceInformation message sent to the network.

The order in which the above conditions are arranged is irrelevant to the conditions, that is, the order of the above conditions may be changed.

Optionally, the UE initiates the transmission of the RRC dedicated message (e.g., the UEAssistanceInformation message) or the MAC CE to send the flight path time information availability indication information and/or the flight path location information availability indication information to the network.

### Embodiment 7

According to Embodiment 1, a variation of step 103 of Embodiment 1 is that, when at least one of the following conditions is met, the UE sends flight path change indication information to the network when at least one of the following conditions is met, the flight path change indication information being used to indicate a flight path change:
a flight path information request (flightPathInfoReq) configuration being included in a UEInformationRequest message received previously, and includeTimeStamp being included in flightPathInfoReq (and includeTimeStamp being set to TRUE);
the UE having available flight path information;
the UE needing to update the flight path due to the flight path change; and
the UE needing to update the flight path due to a flight path time information change.

The order in which the above conditions are arranged is irrelevant to the conditions, that is, the order of the above conditions may be changed.

Alternatively, another variation of step 103 of Embodiment 1 is that, the UE sends flight path change indication information to the network when at least one of the following conditions is met, the flight path change indication information being used to indicate a flight path change:
a flight path information request (flightPathInfoReq) configuration being included in a UEInformationRequest message received previously, and if includeTimeStamp is not included in flightPathInfoReg;
the UE having available flight path information;
the UE having available flight path time information and/or location information; and
the UE needing to update the flight path due to a flight path location information change.

The order in which the above conditions are arranged is irrelevant to the conditions, that is, the order of the above conditions may be changed.

The flight path change indication information may be included in an RRC dedicated message (e.g., a UE assistance information (UEAssistanceInformation) message) or a MAC CE. FIG. 6 is a simplified structural block diagram of a user equipment (UE) according to the present invention. As shown in FIG. 6, a UE 700 includes a processor 701 and a memory 702.

The processor 701 may include, for example, a microprocessor, a microcontroller, an embedded processor, etc. The memory 702 may include, for example, a volatile memory (such as a random access memory (RAM)), a hard disk drive (HDD), a non-volatile memory (such as a flash memory), other memories, or the like. The memory 702 has program instructions stored thereon. The instructions, when run by the processor 701, can perform the above method performed by a user equipment described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies. Furthermore, the present invention is not limited to the embodiments described above.

Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A User Equipment (UE), comprising a processor configured to:
receive an RRC message from a network with a flight path availability configuration which configures the UE to indicate an availability of a flight path, and
in case the UE has the flight path available and has not sent the availability of the flight path since entering RRC_CONNECTED state, send an RRC message with the availability of the flight path to the network.

12. A base station, comprising a processor configured to:
transmit an RRC message to a User Equipment (UE) with a flight path availability configuration which configures the UE to indicate an availability of a flight path, and
in case the UE has the flight path available and has not sent the availability of the flight path since entering RRC_CONNECTED state, receive an RRC message with the availability of the flight path from the network.

13. A method performed by a User Equipment (UE), the method comprising:
receiving an RRC message from a network with a flight path availability configuration which configures the UE to indicate an availability of a flight path, and
in case the UE has the flight path available and has not sent the availability of the flight path since entering RRC_CONNECTED state, sending an RRC message with the availability of the flight path to the network.
